(19) United States
(12) Patent Application Publication
(10) Pub. No.: US 2023/0130348 A1
(43) Pub. Date: Apr. 27, 2023

(54) HOLOGRAPHIC MICROSCOPE AND USING METHOD THEREOF

(71) Applicant: Industrial Technology Research Institute, Hsinchu (TW)

(72) Inventor: Wei-Kang Chang, Taoyuan City (TW)

(73) Assignee: Industrial Technology Research Institute, Hsinchu (TW)

(21) Appl. No.: 17/580,612

(22) Filed: Jan. 20, 2022

(30) Foreign Application Priority Data
Oct. 21, 2021 (TW) 110139149

(51) Int. Cl. G03H 1/04; G03H 1/00

(52) U.S. Cl. CPC G03H 1/0443; G03H 1/0005; G03H 2001/005; G03H 2001/0033; G03H 2210/12; G03H 2223/19; G03H 2222/12

(57) ABSTRACT

A holographic microscope configured to observe a sample is provided. The holographic microscope includes a light source, a light splitting element, a polarizing element, a phase modulation element, a light combining element, and a photosensitive element. The light source is configured to provide an illumination beam. The illuminating beam is transmitted through the light splitting element to form a first light beam and a second light beam, and the sample is disposed on a transmission path of the first light beam. The polarizing element and the phase modulation element are disposed on the transmission path of the first light beam or the second light beam. The first light beam and the second light beam are transmitted to the light combining element to form an interference beam. The photosensitive element is disposed on a transmission path of the interference beam to receive the interference beam to generate an optical signal.

### CROSS-REFERENCE TO RELATED APPLICATION

This application claims the priority benefit of Taiwan application serial no. 110139149, filed on Oct. 21, 2021. The entirety of the above-mentioned patent application is hereby incorporated by reference herein and made a part of this specification.

### TECHNICAL FIELD

The disclosure relates to a holographic microscope.

### BACKGROUND

Generally speaking, conventional holographic microscopes often use mechanical methods to change the optical path difference of the reference light or the measured light in the optical system. As a result, interference fringes are adjusted to solve information such as the optical path and depth of the object to be tested. However, it is easy to generate vibration noises to the system and the object to be tested to use modulation of the moving member in the mechanical method, thereby degrading the display quality. Therefore, how to improve good optical quality has become an issue for people of ordinary skills in the art to work on.

### SUMMARY

The disclosure provides a holographic microscope configured to observe a sample to be tested. The holographic microscope includes a light source, a light splitting element, a polarizing element, a phase modulation element, a light combining element, and a photosensitive element. The light source is configured to provide an illumination beam. The light splitting element is disposed on a transmission path of the illumination beam. The illuminating beam is transmitted through the light splitting element to form a first light beam and a second light beam, and the sample to be tested is disposed on a transmission path of the first light beam. The polarizing element is disposed on the transmission path of the first light beam or a transmission path of the second light beam, and receives the first light beam or the second light beam from the light splitting element. The phase modulation element is disposed on the transmission path of the first light beam or the transmission path of the second light beam. The light combining element is disposed on the transmission path of the first light beam and the transmission path of the second light beam, and the first light beam and the second light beam are transmitted to the light combining element to form an interference beam. The photosensitive element is disposed on a transmission path of the interference beam to receive the interference beam to generate an optical signal.

The disclosure also provides a using method of a holographic microscope to observe a sample to be tested. The holographic microscope includes a light source, a light splitting element, a polarizing element, a phase modulation element, a light combining element, and a photosensitive element. The using method of the holographic microscope includes the following steps. An illumination beam is provided to the light splitting element to form a first light beam and a second light beam. One of the first light beam and the second light beam is transmitted through the polarizing element. One of the first light beam and the second light beam is transmitted through the phase modulation element. The first light beam is transmitted through the sample to be tested. The first light beam and the second light beam are transmitted to the light combining element to form an interference beam. The interference beam is transmitted to the photosensitive element to generate an optical signal.

In order for the aforementioned features and advantages of the disclosure to be more comprehensible, embodiments accompanied with drawings are described in detail below.

### BRIEF DESCRIPTION OF THE DRAWINGS

FIG. 1 is a schematic view of a holographic microscope according to an embodiment of the disclosure.

FIG. 2 is a partially enlarged schematic view of the holographic microscope of FIG. 1.

FIG. 3 is a schematic view of an image signal generated by the holographic microscope of FIG. 1.

FIG. 4 is a schematic view of a holographic microscope according to another embodiment of the disclosure.

FIG. 5 is a schematic view of a holographic microscope according to another embodiment of the disclosure.

FIG. 6 is a schematic view of a holographic microscope according to another embodiment of the disclosure.

FIG. 7 is a flow chart of steps of using a holographic microscope according to an embodiment of the disclosure.

### DETAILED DESCRIPTION OF DISCLOSED EMBODIMENTS

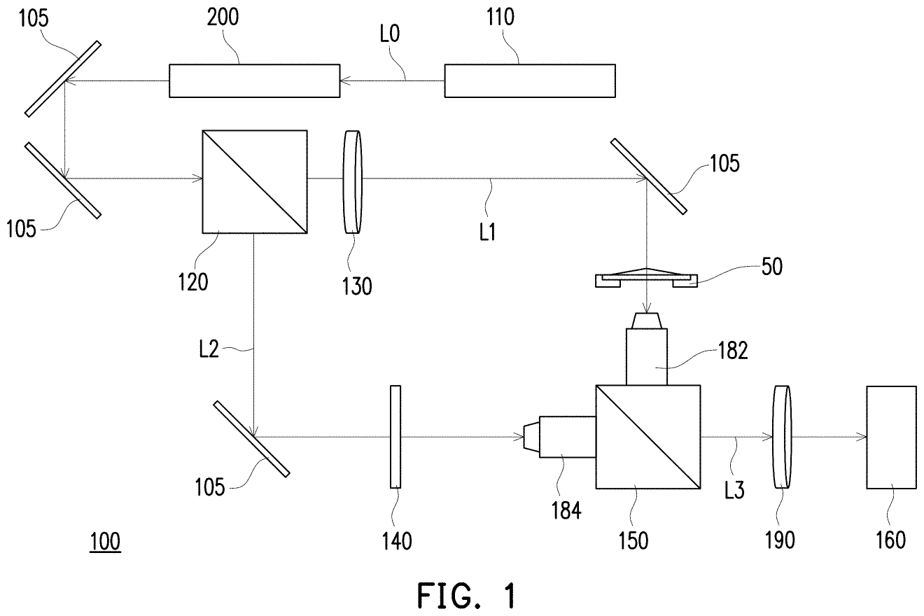

FIG. 1 is a schematic view of a holographic microscope according to an embodiment of the disclosure. This embodiment provides a holographic microscope 100 configured to electrically connecting to a computing device (for example, a computer), so as to observe a sample 50 to be tested, and then display a plane display view and a perspective display view of the sample 50 to be tested. The sample 50 to be tested is, for example, a tiny object such as a biological cell, or a living cell immersed in a culture liquid, but the disclosure is not limited thereto. The holographic microscope 100 includes a light source 110, a light splitting element 120, a polarizing element 130, a phase modulation element 140, a light combining element 150, and a photosensitive element 160.

The light source 110 is configured to provide an illumination beam LO, and the light splitting element 120 is disposed on a transmission path of the illumination beam LO. The illumination beam L0 is transmitted through the light splitting element 120 to form a first light beam L1 and a second light beam L2, and the sample 50 to be tested is disposed on a transmission path of the first light beam L1. In this embodiment, the light source 110 is a laser device, so the illumination beam L0 is a laser beam with high coherence. The light splitting element 120 is a polarization beam splitter (PBS), which is configured to split light beams with different linear polarization states. In other words, in this embodiment, the illumination beam L0 includes a first polarization state light and a second polarization state light that are orthogonal (for example, P polarization and S polarization), and polarization states of the first light beam L1 and the second light beam L2 are different. In addition, in this embodiment, the holographic microscope 100 further includes a filter element 200, which is disposed on the transmission path of the illumination beam L0 and located between the light source 110 and the light splitting element 120. The filter element 200 is, for example, a spatial filter, which is configured to expand the laser beam and achieve an effect of spatial light field filtering.

The polarizing element 130 is disposed on the transmission path of the first light beam L1 or a transmission path of the second light beam L2 to receive the first light beam L1 or the second light beam L2 from the light splitting element 120. For example, in this embodiment, the polarizing element 130 is disposed on the transmission path of the first light beam L1, and receives the first light beam L1 from the light splitting element 120. That is, the polarizing element 130 is disposed on the transmission path of the light where the sample 50 to be tested is located. However, the disclosure is not limited thereto. The polarizing element 130 is, for example, a half-wave plate, which is configured to match with the light splitting element 120 of the polarization beam splitter, so that the polarization state of the first light beam L1 passing through the polarizing element 130 may be converted into the same polarization state as that of the second light beam L2, so as to facilitate a subsequent optical interference.

The phase modulation element 140 is disposed on the transmission path of the first light beam L1 or the transmission path of the second light beam L2. For example, in this embodiment, the phase modulation element 140 is disposed on the transmission path of the second light beam L2. That is, the phase modulation element 140 is disposed on a transmission path of a reference light, but the disclosure is not limited thereto. The phase modulation element 140 is, for example, a liquid crystal phase modulator, which is configured to adjust a phase of the transmitted light beam. Therefore, in this embodiment, no additional moving element is required to adjust an optical path difference of the two light beams, which may reduce vibration of a system and then improve optical quality.

The light combining element 150 is disposed on the transmission path of the first light beam L1 and the transmission path of the second light beam L2, and the first light beam L1 and the second light beam L2 are transmitted to the light combining element 150 to form an interference beam L3. The light combining element 150 is a beam splitter, for example, to reflect the first light beam L1 and allow the second light beam L2 to pass through to be combined into the interference beam L3. Specifically, in this embodiment, the first light beam L1 is transmitted by the light splitting element 120 through the polarizing element 130 and the sample 50 to be tested successively to be transmitted to the light combining element 150, and the second light beam L2 is transmitted by the light splitting element 120 through the phase modulation element 140 to be transmitted to the light combining element 150.

In different embodiments, the holographic microscope 100 may be configured with multiple reflective elements 105, such as mirrors, to guide the light beam or adjust a direction of a light path. For example, in this embodiment, the reflective elements 105 may be respectively disposed between the filter element 200 and the light splitting element 120, between the polarizing element 130 and the sample 50 to be tested, and between the light splitting element 120 and the phase modulation element 140. However, the disclosure does not limit the type, number, or disposing position thereof.

It is worth mentioning that in this embodiment, the holographic microscope 100 further includes a first objective 182 and a second objective 184. The first objective 182 is disposed on the transmission path of the first light beam L1, and is located between the sample 50 to be tested and the light combining element 150. The second objective 184 is disposed on the transmission path of the second light beam L2, and is located between the phase modulation element 140 and the light combining element 150. An optical specification of the first objective 182 is the same as an optical specification of the second objective 184, that is, the same micro objective. The optical specification is, for example, a magnification (M), a numerical aperture (NA), and a working distance, etc. In addition, in this embodiment, the first objective 182 is connected to the light combining element 150, and the second objective 184 is connected to the light combining element 150. The first objective 182 and the second objective 184 are connected to different sides of the light combining element 150. In this way, a structure of the dual objectives in which the first objective 182 and the second objective 184 with the same optical specification are respectively disposed at the first beam L1 and the second beam L2 may compensate each other, reduce an optical defect such as a phase difference of the single objective, and optimize instability of the conventional technology.

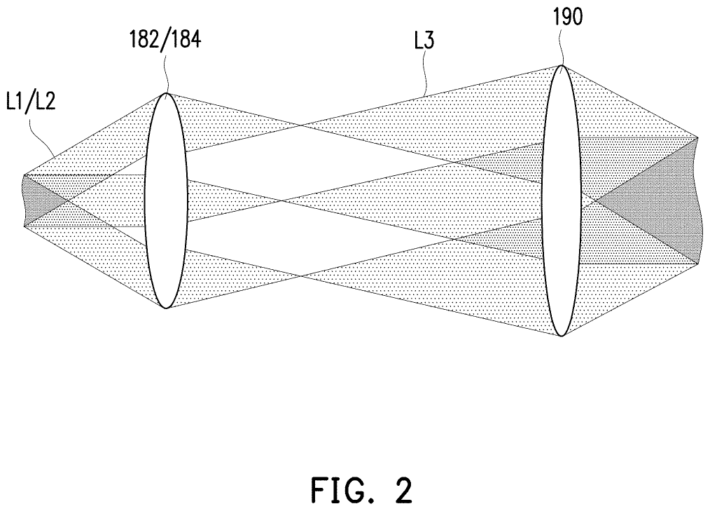

FIG. 2 is a partially enlarged schematic view of the holographic microscope of FIG. 1. Referring to FIGS. 1 and 2, on the other hand, in this embodiment, the holographic microscope 100 further includes a lens module 190, which is disposed on a transmission path of the interference beam L3, and is located between the light combining element 150 and the photosensitive element 160. The lens module 190 is a tube lens. Therefore, by using the first objective 182 and the second objective 184 respectively with the lens module 190, the holographic microscope 100 may achieve effects of reducing an optical aberration and increasing a field of view (FOV) (as shown in the FIG. 2).

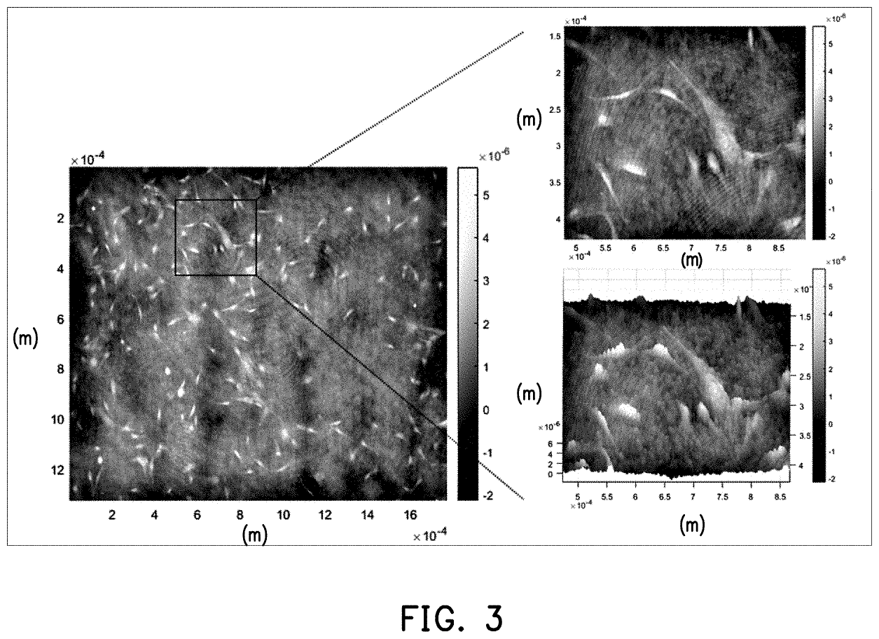

FIG. 3 is a schematic view of an image signal generated by the holographic microscope of FIG. 1. Referring to FIGS. 1 and 3, the photosensitive element 160 is disposed on the transmission path of the interference beam L3 to receive the interference beam L3 to generate an optical signal. The photosensitive element 160 is, for example, a charge coupled device (CCD) or complementary metal oxide semiconductor transistors (CMOS), but the disclosure is not limited thereto. The interference beam L3 is transmitted by the light combining element 150 to the lens module 190 and the photosensitive element 160 successively, so as to generate the optical signal for use by the computing device. In some embodiments, the computing device may be built in the holographic microscope 100, but the disclosure is not limited thereto. Finally, the computing device obtains an image of the sample 50 to be tested through computing. In this way, it is possible to adjust a phase difference between a sample beam and the reference beam without disposing other moving members, thereby obtaining a good display effect through a high-precision optical system and calculation. FIG. 3 may display the image signal generated by the holographic microscope, which may effectively obtain a cell thickness, helpful to obtain more information about an active state of an object to be tested.

For example, in this embodiment, by measuring the interference beam L3, a phase-shifting algorithm (PSA) may be used to calculate the measured interference beam L3, so as to obtain a phase difference between the first light beam L1 and the second light beam L2. In this embodiment, the phase-shifting algorithm may be a three-step phase-shifting algorithm, a four-step phase-shifting algorithm, or a five-step phase-shifting algorithm. The so-called three-step phase-shifting algorithm is to use the phase modulation element 140 to respectively adjust a phase difference of the two light beams to 0, 2 λ/3, and 4λ/3 and shoot an image each to solve a phase of each point by an algorithm. The four-step phase-shifting algorithm is to use the phase modulation element 140 to respectively adjust the phase difference of the two light beams to 0, λ/2, λ, and 3 λ/2 and shoot an image each to solve the phase of each point by the algorithm. The five-step phase-shifting algorithm is to use the phase modulation element 140 to respectively adjust the phase difference of the two light beams to 0, λ/2, λ, 3λ/2, and 2λ and shoot an image each to solve the phase of each point by the algorithm. In different embodiments, a more accurate sensing result may be obtained by using the phase-shifting algorithm of more steps, while time may be saved and factors of instability may be reduced by using the phase-shifting algorithm of less steps. Therefore, the holographic microscope 100 in this embodiment may use different phase-shifting algorithm to perform calculations according to different requirements, but the disclosure is not limited thereto.

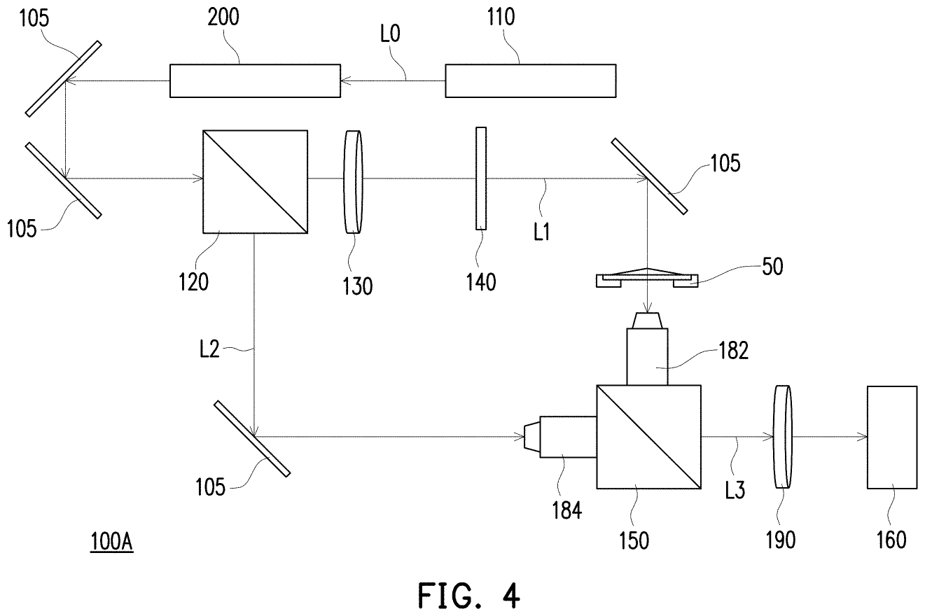

FIG. 4 is a schematic view of a holographic microscope according to another embodiment of the disclosure. Referring to FIG. 4, a holographic microscope 100A shown in this embodiment is similar to the holographic microscope 100 shown in FIG. 1. A difference between the two is that, in this embodiment, the phase modulation element 140 is disposed on the transmission path of the first light beam L1, and is located between the polarizing element 130 and the sample 50 to be tested. In this way, it is possible to adjust the phase difference between the sample beam and the reference beam without disposing other moving members, thereby obtaining the good display effect through the high-precision optical system and calculation.

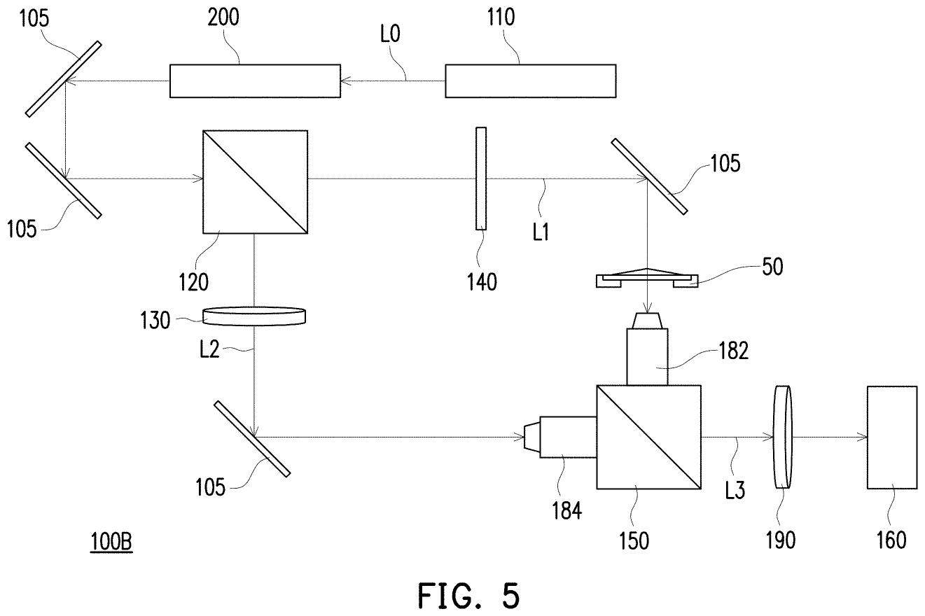

FIG. 5 is a schematic view of a holographic microscope according to another embodiment of the disclosure. Referring to FIG. 5, a holographic microscope 100B shown in this embodiment is similar to the holographic microscope 100 shown in FIG. 1. A difference between the two is that, in this embodiment, the polarizing element 130 is disposed on the transmission path of the second light beam L2, while the phase modulation element 140 is disposed on the transmission path of the first light beam L1, and the sample 50 to be tested is located between the phase modulation element 140 and the light combining element 150. In this way, it is possible to adjust the phase difference between the sample beam and the reference beam without disposing other moving members, thereby obtaining the good display effect through the high-precision optical system and calculation.

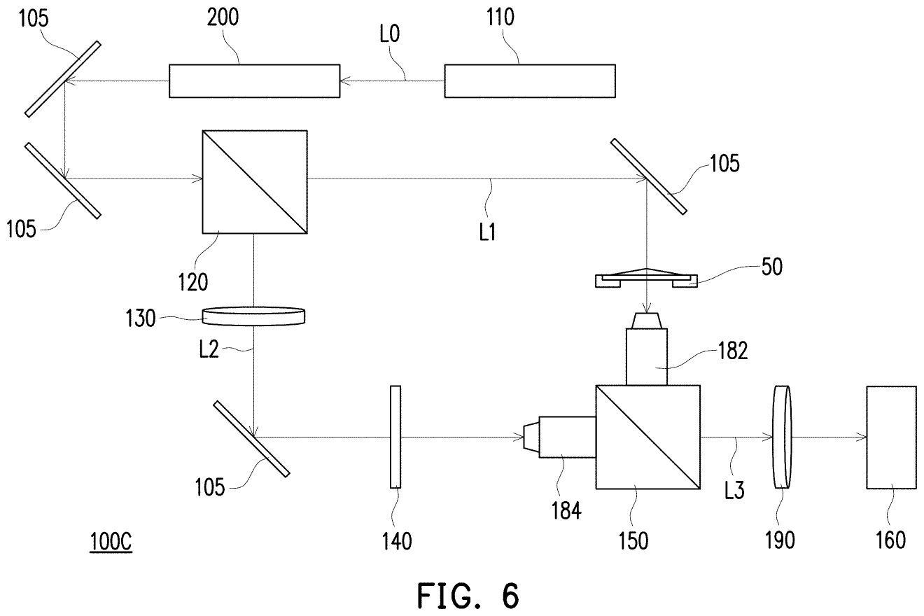

FIG. 6 is a schematic view of a holographic microscope according to another embodiment of the disclosure. Referring to FIG. 6, a holographic microscope 100C shown in this embodiment is similar to the holographic microscope 100 shown in FIG. 1. A difference between the two is that, in this embodiment, the polarizing element 130 and the phase modulation element 140 are both disposed on the transmission path of the second light beam L2. In this way, it is possible to adjust the phase difference between the sample beam and the reference beam without disposing other moving members, thereby obtaining the good display effect through the high-precision optical system and calculation.

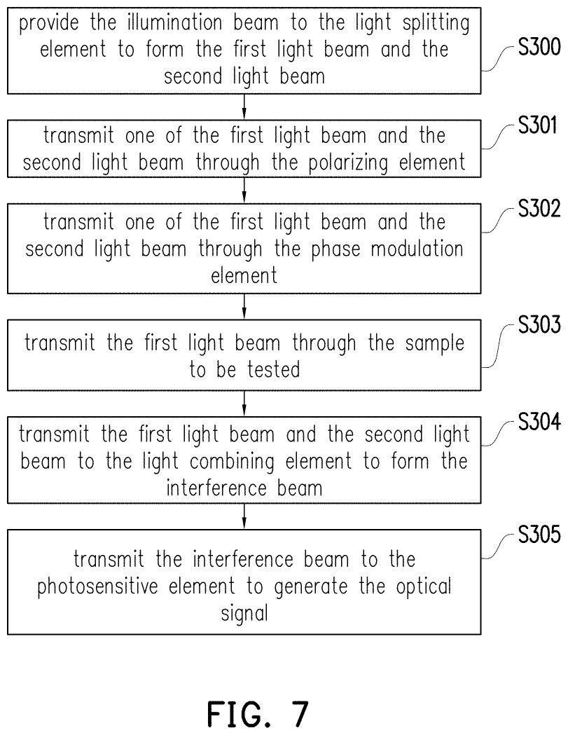

FIG. 7 is a flow chart of steps of using a holographic microscope according to an embodiment of the disclosure. Referring to FIGS. 1 and 7, the flow chart of the steps of using the holographic microscope in this embodiment may at least be applied to the holographic microscope 100 shown in FIG. 1. Therefore, the holographic microscope 100 of FIG. 1 is taken as an example for illustration, but the disclosure is not limited thereto. In a using method of the holographic microscope 100 in this embodiment, first, step 5300 is performed to provide the illumination beam L0 to the light splitting element 120 to form the first light beam L1 and the second light beam L2. Specifically, the light source 110 is configured to provide the illumination beam L0 to the light splitting element 120, and the transmission path of the first light beam L1 is different from the transmission path of the second light beam L2.

Then, after the above step, step 5301 is performed to transmit one of the first light beam L1 and the second light beam L2 through the polarizing element 130. For example, in this embodiment, the polarizing element 130 is disposed on the transmission path of the first light beam L1. Therefore, in this step, the first light beam L1 is transmitted through the polarizing element 130, but the disclosure is not limited thereto. After the above step, step 5302 is performed to transmit one of the first light beam L1 and the second light beam L2 through the phase modulation element 140. For example, in this embodiment, the phase modulation element 140 is disposed on the transmission path of the second light beam L2. Therefore, in this step, the second light beam L2 is transmitted through the phase modulation element 140, but the disclosure is not limited therefore.

Next, after the above step, step 5303 is performed to transmit the first light beam L1 through the sample 50 to be tested. Specifically, the sample 50 to be tested is disposed on the transmission path of the first light beam L1 to allow the first light beam L1 to pass through. After the above step, step 5304 is performed to transmit the first light beam L1 and the second light beam L2 to the light combining element 150 to form the interference beam L3. In other words, the first light beam L1 and the second light beam L2 are combined by the light combining element 150 to generate interference. Finally, after the above step, step 5305 is performed to transmit the interference beam L3 to the photosensitive element 160 to generate the optical signal. In this way, it is possible to adjust the phase difference between the sample beam and the reference beam without disposing other moving members, thereby obtaining the good display effect through the high-precision optical system and calculation. The using method of the holographic microscope 100 in this embodiment may effectively obtain the cell thickness, which is helpful to obtain more information about the active state of the object to be tested.

Based on the above, in the holographic microscope in the embodiment of the disclosure, the light source provides the illumination beam to the light splitting element to generate the first light beam and the second light beam to be transmitted through the sample to be tested to generate the interference beam after passing the light combining element, which is sensed through the photosensitive element and subjected to subsequent calculations to obtain a display image. The optical system is configured with the polarizing element to be used with the light splitting element to achieve an optical effect with strong light intensity. The optical system is additionally configured with the phase modulation element to optimize the factors of instability in the conventional architecture. In this way, it is possible to adjust the phase difference between the sample beam and the reference beam without disposing other moving members, thereby obtaining the good display effect through the high-precision optical system and calculation. The image signal generated by the holographic microscope in the embodiment of the disclosure may effectively obtain the cell thickness, which is helpful to obtain more information about the active state of the object to be tested.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A holographic microscope configured to observe a sample to be tested, comprising:
a light source configured to provide an illumination beam;
a light splitting element disposed on a transmission path of the illumination beam, wherein the illumination beam is transmitted through the light splitting element to form a first light beam and a second light beam, and the sample to be tested is disposed on a transmission path of the first light beam;
a polarizing element disposed on the transmission path of the first light beam or a transmission path of the second light beam, and receiving the first light beam or the second light beam from the light splitting element;
a phase modulation element disposed on the transmission path of the first light beam or the transmission path of the second light beam;
a light combining element disposed on the transmission path of the first light beam and the transmission path of the second light beam, wherein the first light beam and the second light beam are transmitted to the light combining element to form an interference beam; and
a photosensitive element disposed on a transmission path of the interference beam to receive the interference beam to generate an optical signal.

2. The holographic microscope according to claim 1, further comprising:
a first objective disposed on the transmission path of the first light beam, wherein the first objective is located between the sample to be tested and the light combining element; and
a second objective disposed on the transmission path of the second light beam, wherein an optical specification of the first objective is the same as an optical specification of the second objective.

3. The holographic microscope according to claim 2, wherein the first objective is connected to the light combining element, the second objective is connected to the light combining element, and the first objective and the second objective are connected to different sides of the light combining element.

4. The holographic microscope according to claim 1, wherein the light splitting element is a polarization beam splitter, the polarizing element is a half-wave plate, the phase modulation element is a liquid crystal phase modulator, and the light combining element is beam splitter.

5. The holographic microscope according to claim 1, further comprising:
a lens module disposed on the transmission path of the interference beam, and is located between the light combining element and the photosensitive element.

6. The holographic microscope according to claim 1, wherein the polarizing element is disposed on one of the transmission paths of the first light beam and the second light beam, and the phase modulation element is disposed on the other one of the transmission paths of the first light beam and the second light beam.

7. The holographic microscope according to claim 1, wherein the phase modulation element is located between the polarizing element and the sample to be tested.

8. The holographic microscope according to claim 1, wherein the polarizing element and the phase modulation element are both disposed on the transmission path of the first light beam or the transmission path of the second light beam.

9. The holographic microscope according to claim 8, wherein the phase modulation element is located between the polarizing element and the sample to be tested.

10. The holographic microscope according to claim 1, wherein the light source is a laser device.

11. The holographic microscope according to claim 10, further comprising:
a filter element disposed on the transmission path of the illumination beam and located between the light source and the light splitting element.

12. A using method of a holographic microscope to observe a sample to be tested, wherein the holographic microscope comprises a light source, a light splitting element, a polarizing element, a phase modulation element, a light combining element, and a photosensitive element, and the using method of the holographic microscope comprises:
providing an illumination beam to the light splitting element to form a first light beam and a second light beam;
transmitting one of the first light beam and the second light beam through the polarizing element;
transmitting one of the first light beam and the second light beam through the phase modulation element;
transmitting the first light beam through the sample to be tested;
transmitting the first light beam and the second light beam to the light combining element to form an interference beam; and
transmitting the interference beam to the photosensitive element to generate an optical signal.

13. The using method of the holographic microscope according to claim 12, wherein the holographic microscope further comprises a first objective and a second objective, and the using method of the holographic microscope further comprises:
transmitting the first light beam through the first objective; and
transmitting the second light beam through the second objective, wherein an optical specification of the first objective is the same as an optical specification of the second objective.

14. The using method of the holographic microscope according to claim 12, wherein the holographic microscope further comprises a lens module, and the using method of the holographic microscope further comprises:
transmitting the interference beam through the lens module.

15. The using method of the holographic microscope according to claim 12, wherein the holographic microscope further comprises a filter element, and the using method of the holographic microscope further comprises:
transmitting the illumination beam through the filter element.
